(19) United States
(12) Patent Application Publication
(10) Pub. No.: US 2011/0180515 A1
(43) Pub. Date: Jul. 28, 2011

(54) EXTINGUISHING PLATE FOR AN ARC EXTINGUISHING CHAMBER

(75) Inventors: Volker Behrens, Bretten (DE); Thorsten Maldener, Pforzheim (DE); Thomas Honig, Pforzheim (DE)

(73) Assignee: Doduco GmbH, Pforzheim (DE)

(21) Appl. No.: 13/056,403

(22) PCT Filed: Jul. 8, 2009
(86) PCT No.: PCT/EP2009/004916

§ 371 Date: Mar. 11, 2011

(30) Foreign Application Priority Data
Jul. 31, 2008 (DE) 10 2008 035 974.2

(51) Int. Cl. H01H 9/34

(52) U.S. Cl. 218/150

(57) ABSTRACT

The invention relates to a quenching plate made of a matrix composite material, comprising a ferromagnetic phase in which a high temperature stable phase is embedded. Example of an embodiment: In order to produce the matrix composite material, 96 wt. % iron and 4 wt. % MgO are mixed. The powder mixture is pressed into green plates. The green plate are sintered and rolled into the desired thickness of 0.8 mm to 1.2 mm The rolling can be done in several rolling steps, between which the sinter plates are aged. After the last rolling step, the sinter plates are preferably aged once more. The plates produced of the matrix composite material in said way are then coated galvanically with a 5 to 10 micrometer thin electrically conductive layer, for example a copper layer.

The invention relates to extinguishing plates for arc extinguishing chambers in switching devices, particularly in circuit breakers. Such extinguishing plates, which frequently are also referred to as arc splitter plates, are known from WO 2006/010572 A1, for example.

When closing and opening circuits under electric load, different electric discharge phenomena are encountered at the electric contacts, depending on the voltage and amperage. If the voltage and amperage are high enough, the surface of the contacts is subjected to arcing effects during each switching operation, which considerably influence the service lives of the contacts. As a result of the arcing effect, contact material is lost (burn-off). If the contact gaps are larger, of the kind found in circuit breakers, for example, the burned-off contact material is predominantly lost to the surroundings. So as to keep the material burn-off low, it is desirable to minimize the duration of the arc on the contact surfaces.

On closing, the burning duration of the arc is primarily determined by the bouncing duration of the contacts and the waveform of the making current. When breaking alternating currents, arcing continues below a critical current from the moment the contact is opened until the next zero crossing; then the arc is self-extinguished.

Above a critical current, special measures are required to extinguish the arc. It is known to cool or split the arc for this purpose. To this end, extinguishing chambers in the switching devices are known. Arcs are split into partial arcs in extinguishing chambers, which contain an array of extinguishing plates according to the deionization principle. In an extinguishing chamber operating according to the deionization principle, typically 1 mm thick metal sheets are disposed parallel to each other or in a fan shape and mutually isolated. The materials used for the extinguishing plates are ferromagnetic materials because the magnetic field accompanying the arc in the vicinity of a ferromagnetic material always strives to flow through the extinguishing plates having better magnetic conductivity. This creates a suction effect toward the extinguishing plates. In addition to a magnetic blowout field generated directly by the arc, this suction effect also causes the arc to move relative to the array of extinguishing plates and being split among them.

It is known to produce extinguishing plates from soft iron. In order to prevent local overheating at the arc roots on the extinguishing plates and worsening of the cooling of the arc, there is a desire for high mobility of the arc roots on the extinguishing plates. For this purpose, it is known to electro-silverplate or copperplate the extinguishing plates. Nonetheless, the action of the arc repeatedly results in local melting and spattering of the melted material of the extinguishing plate. The risk of spattering exists because the arc, like lightning, is accompanied by gas flows which can reach the speed of sound and manifest themselves in a bang. The rapid gas flows may entrain droplets of the melted iron. The droplets can short-circuit individual extinguishing plates, thereby rendering them ineffective.

However, they may also stray in the switching device and deposit, for example, on the contact surfaces, where they cause the contact resistance to increase.

So as to counteract the spattering of the melted material of the extinguishing plates, WO 2006/010572 A1 teaches the use of coated extinguishing plates, which comprise a ferromagnetic main body carrying a protective layer 0.05 mm to 0.3 mm thick and containing high-temperature resistant particles. The surface of the protective layers described in WO 2006/010572 A1 is made 30% to 70% of high-temperature resistant material.

Safety regulations generally require flawless switching behavior during at least three consecutive openings under short-circuit conditions. While this may be achieved by extinguishing plates comprising the protective layers known from WO 2006/010572 A1, the known protective layers are typically destroyed quickly by arcing, and the extinguishing plates must soon be replaced. Thicker protective layers, however, cause increasing shielding of the ferromagnetic main body located underneath, so that the arc is pulled less strongly into the extinguishing plates and is therefore more difficult to extinguish.

It is therefore the object of the present invention to reduce the disadvantages of known arc extinguishing chambers and create an extinguishing chamber that can withstand a larger number of switching cycles under short circuit conditions, while offering good extinguishing properties.

This object is achieved by an extinguishing plate having the characteristics of claim 1. Advantageous refinements of the invention are the subject matter of the dependent claims.

An extinguishing plate according to the invention comprises a matrix composite material, wherein a high-temperature resistant phase is embedded in a ferromagnetic phase. In an extinguishing plate according to the invention, the magnetic field attracting the arc is intensified by the ferromagnetic phase of the composite material. A separate protective layer, which contains the high-temperature resistant particles like the protective layer known from WO 2006/010572 A1, can be foregone because the resistance of the matrix composite material, of which the extinguishing plate according to the invention is made, against the effect of arcing is increased due to the high-temperature resistant phase.

If burn-off of material of the matrix composite should still occur, advantageously this does not result in a sudden worsening of the function of the extinguishing plate, as is the case during the burn-off of a protective layer containing high-temperature resistant particles according to WO 2006/010572 A1 on a ferromagnetic main body. The thickness of the matrix composite material causes the resistance of the extinguishing plate to arcing to be maintained, even if considerable burn-off has occurred. Contrary to known extinguishing plates, resistance after burn-off may even increase, because particles of the high-temperature resistant phase accumulate on the surface of the composite material due to arcing.

The high-temperature resistant phase is preferably uniformly distributed in the matrix composite material. Uniform distribution shall not be understood as homogeneous distribution, because the size of the particles of the high-temperature resistant phase and also the distribution of the particles of the high-temperature resistant phase in the ferromagnetic phase are subject to statistical fluctuations. The desired “uniform” distribution therefore denotes distribution in which the uniformity is subject to statistical fluctuations.

An extinguishing plate according to the invention is preferably made entirely, this being 100%, of the matrix composite material. However, this is not absolutely required to use the benefits according to the invention. For example, an extinguishing plate according to the invention may be embedded into reinforcement and/or the extinguishing plate may carry a thin, electrically conductive coating as the cover layer.

Surprisingly, an extinguishing plate according to the invention can even be improved when it carries a thin coating, and particularly a diamagnetic or paramagnetic coating, on the matrix composite material. In particular, a coating comprising a material having good conductivity, such as copper, silver, or a copper or silver alloy, may result in considerably improved arc extinguishing properties, at least for several switching cycles, more specifically even if the coating is only still present in some regions. The thin coating is preferably no more than 20 micrometers, for example 3-13 micrometers, thick. Such a metal layer can be applied onto the matrix composite material by electro-deposition, for example. Further possibilities include PVD, CVD, or thermal spraying.

As an alternative, thin coatings made of plastic are also possible, which burn off quickly, but contribute to particularly fast extinguishing of the arc. Plastic coatings may be applied, for example, as paint, using a screen printing method, or using a powder coating method.

It is always preferred, however, for the matrix composite material to fill in the predominant part of the volume of the extinguishing plate. It is particularly preferred for the matrix composite material to fill in at least 70%, preferably at least 80% of the volume of the extinguishing plate.

A refinement of the invention is an extinguishing plate which is composed of two extinguishing plates according to the invention and in which the two extinguishing plates are joined by a metallic intermediate layer, which does not contain a high-temperature resistant phase and which has a small thickness compared to the thickness of the composite extinguishing plate. Such a composite extinguishing plate may contain a sheet metal or a metal foil as the intermediate layer, on the top side and underside of which the composite has been deposited, for example. Such an intermediate layer—even together with potentially present cover layers of the matrix composite material—accounts for considerably less than half the thickness of the composite extinguishing plate. Even if thin sheet metal that is not ferromagnetic is used as the intermediate layer, the magnetic properties of the composite extinguishing plate are decisively influenced by the ferromagnetic phase of the matrix composite material, because this material fills in a larger volume than an intermediate layer that may be present.

The high-temperature resistant phase of the matrix composite material may be a phase having a high melting point, for example a metal. It is also possible for the high-temperature resistant phase not to melt when a high critical temperature is reached, but to sublimate or decompose instead, as some ceramic materials do.

The matrix composite material may in particular comprise ceramic grains or refractory metals as the high-temperature resistant phase, notably materials that withstand temperatures of at least 1900° C., preferably at least 2400° C., which is to say they have a phase change temperature of at least 1900° C., and preferably of more than 2400° C. Both oxide ceramics such as MgO, ZrO₂, Al₂O₃, ZrSiO₄, MgAl₂O₄, and carbides, nitrides, silicides and borides are suited, for example SiC, TiC, ZrC, B₄C₃, WC, Mo₂C, VC, BN, AIN, TiN, Si₃N₄, WSi₂, MoSi₂, Nb₅Si₃, Ta₅Si₃, TiB₂, ZrB₂. W, Nb, Ta, Mo, V, and Cr are suitable refractory metals, for example. The matrix composite material may also contain different ceramic grains or metals having high melting points. When speaking of a high-temperature resistant phase in connection with the matrix composite material according to the invention, it shall be understood to mean all high-temperature resistant materials present in the matrix composite material. In the case of a matrix composite material that comprises, for example, 5% by volume MgO and 5% by volume W, the high-temperature resistant phase within the meaning used here thus has a content of 10% by volume.

The ferromagnetic phase of the matrix composite material is preferably made of iron or an iron alloy, however it may also be made of nickel and/or cobalt or of ferromagnetic alloys, for example. In principle, the matrix composite material may also contain several physically or chemically different ferromagnetic phases. When speaking of a ferromagnetic phase in connection with the matrix composite material of an extinguishing plate according to the invention, it shall be understood to mean all ferromagnetic phase present in the material.

The high-temperature resistant phase of an extinguishing plate according to the invention is preferably distributed over the entire thickness of the composite material, and in particular uniformly. The production is carried out, for example, by powder metallurgy, smelting metallurgy, continuous casting, saturating a porous base structure, or a powder filling comprising high-temperature resistant material with ferromagnetic matrix material, thermal spraying of matrix material and refractory additive on a metallic substrate, or electro-deposition of a matrix with the integration of a high-temperature resistant phase. Such a distribution of the high-temperature resistant phase in the matrix composite material, however, is not absolutely necessary.

An extinguishing plate according to the invention is preferably 0.4 mm to 3 mm, and particularly 0.8 mm to 1.8 mm thick. The matrix composite material used according to the invention is therefore preferably between 0.4 and 3 mm, and particularly between 0.8 mm and 1.8 mm thick. It is therefore preferred according to the invention that the thickness of the matrix composite material is substantially identical to the thickness of the extinguishing plate.

In an extinguishing plate according to the invention, the matrix composite material may comprise further phases, in addition to a ferromagnetic phase and a high-temperature resistant phase, for example a phase having good electric conductivity, notably copper or a copper alloy. An additional phase can considerably increase the electric conductivity of the composite material, so that the material is heated less when extinguishing an arc and consequently experiences less stress. The ferromagnetic phase preferably comprises more than half the volume of the matrix composite material, preferably at least 70%, and more particularly at least 85%. A high content of the ferromagnetic phase may advantageously generate a strong magnetic force due to interaction with the arc, the force causing the arc to migrate very quickly into an extinguishing plate array and being split and extinguished.

The high-temperature resistant phase of the matrix composite material preferably fills in at least 5%, and preferably at least 10% of the volume. Relatively small contents of the high-temperature resistant phase are frequently sufficient, because the high-temperature resistant phase can accumulate on the surface of the matrix composite material when the remaining phase(s) of this material melt. The high-temperature resistant phase therefore preferably accounts for less than 25%, preferably less than 20%, and particularly less than 15% of the volume of the matrix composite material.

### EMBODIMENTS

1. In order to produce the matrix composite material, 96% by weight iron and 4% by weight MgO are mixed. The powder mixture is pressed into green sheets. The green sheets are sintered and rolled to the desired thickness of 0.8 mm to 1.2 mm. The rolling operation may be carried out in a plurality of rolling steps, between which the sinter plates are aged. After the last rolling step, the sinter plates are preferably aged again. The matrix composite material plates produced in this way are then electro-plated with an electrically conductive layer, for example a copper layer, 5 to 10 micrometers thin.
2. A ferromagnetic iron-nickel alloy is thermally sprayed together with a high-temperature resistant additive, for example tungsten, onto a substrate until a desired thickness of 0.5 mm to 2 mm is reached. The substrate may be made of an easily removable material such as cardboard or textile woven fabric, for example. After the substrate has been removed, the composite material created in this way is electroplated with 5-10 micrometers silver or silver alloy. However, it is also possible to use thin sheet metal, for example aluminum or iron, as the substrate, on the top side and underside of which the matrix composite material is produced by spraying. The matrix composite material is applied to the top side and underside of the substrate until the two layers of the matrix composite material formed in this way are considerably thicker than the substrate, for example at least three times as thick.
3. 97% by weight iron powder and 3% by weight ZrSiO₄ are mixed and subsequently undergo hot isostatic pressing of the powder mixture. The matrix composite material created in this way can be pressed directly into the desired plate thickness and subsequently coated with a conductive plastic paint.
4. An iron-cobalt alloy is electro-deposited onto a conductive substrate while integrating a high-temperature resistant additive, for example Al₂O₃. This conductive substrate can be removed after the deposition process has been completed.

1. An extinguishing plate comprising a matrix composite material, which contains a ferromagnetic phase in which a high-temperature resistant phase is embedded.

2. The extinguishing plate according to claim 1, wherein the high-temperature resistant phase is uniformly distributed in the matrix composite material.

3. The extinguishing plate according to claim 1, wherein the predominant part of the plate volume is filled in by the matrix composite material.

4. The extinguishing plate according to claim 3, wherein the majority of the thickness of the plate comprises the matrix composite material.

5. The extinguishing plate according to claim 1, wherein at least 70% of the plate volume or thickness, and preferably at least 80% of the plate volume or thickness, is filled in by the matrix composite material.

6. The extinguishing plate according to claim 1, wherein the plate is made completely of the matrix composite material.

7. An extinguishing plate according to claim 3, wherein a cover layer having a thickness than is small compared to the thickness of the extinguishing plate.

8. The extinguishing plate according to claim 7, wherein the cover layer is no more than 50 μm thick.

9. The extinguishing plate according to claim 7, wherein the cover layer comprises a material having higher electric conductivity than the electric conductivity of the matrix composite material.

10. An extinguishing plate according to claim 7, wherein the matrix composite material and the material of the cover layer are selected so that the material of the cover layer wets the matrix composite material in the melted state.

11. The extinguishing plate according to claim 7 wherein the cover layer comprises plastic.

12. An extinguishing plate according to claim 1, wherein the high-temperature resistant phase has a melting point or decomposition point or sublimation point of at least 1900° C.

13. An extinguishing plate according to claim 1, wherein it is 0.4 mm to 3 mm, and particularly 0.8 mm to 1.8 mm thick.

14. An extinguishing plate according to claim 1, wherein the high-temperature resistant phase fills in at least 2%, and preferably at least 4%, of the volume of the matrix composite material.

15. An extinguishing plate according to claim 1, wherein the high-temperature resistant phase fills in less than 50%, preferably less than 20%, and particularly less than 15% of the volume of the matrix composite material.

16. An extinguishing plate according to claim 1, wherein the ferromagnetic phase accounts for more than half the volume of the matrix composite material, preferably at least 70%, and particularly at least 85% of the volume.

17. An extinguishing plate according to claim 1, wherein reinforcement is embedded in the matrix composite material.

18. The extinguishing plate according to claim 17, wherein the reinforcement is electrically conductive.

19. The extinguishing plate according to claim 17, wherein the reinforcement comprises fibers.

20. An extinguishing plate according to claim 17, wherein the reinforcement comprises a mesh or grid.

21. A composite extinguishing plate, in which two extinguishing plates according to claim 1 are joined by a metallic intermediate layer, which has a thickness that is small compared to the thickness of the composite extinguishing plate, wherein the intermediate layer does not comprise a high-temperature resistant phase.

22. The composite extinguishing plate according to claim 21, wherein the intermediate layer accounts for no more than 15% of the thickness of the composite extinguishing plate.

23. (canceled)

24. An extinguishing chamber comprising a stack of a plurality of electrically mutually isolated extinguishing plates according to claim 1.
